(19) United States
(12) Patent Application Publication
(10) Pub. No.: US 2025/0050156 A1
(43) Pub. Date: Feb. 13, 2025

(54) PROCESSES AND APPARATUSES FOR CONVERTING POLY- AND PERFLUOROALKYL SUBSTANCES

(71) Applicant: UOP LLC, Des Plaines, IL (US)

(72) Inventors: Elizabeth Jensen, Des Plaines, IL (US); Erick J. Bennett, III, New Lenox, IL (US); Evgeny T. Kolev, Arlington Heights, IL (US); William J. Whyman, Collinsville, OK (US); Aric G. Fisher, Tulsa, OK (US); Aziz Sattar, Itasca, IL (US); Ninart Narthasilpa, Chicago, IL (US); Robert Sanger, Mount Prospect, IL (US)

(21) Appl. No.: 18/620,189

(22) Filed: Mar. 28, 2024

Related U.S. Application Data
(60) Provisional application No. 63/518,029, filed on Aug. 7, 2023.

(51) Int. Cl. A62D 3/38; A62D 101/22; B01D 46/00; B01D 53/04; B01D 53/06; B01D 53/75; B01D 53/78; B01D 53/86

(52) U.S. Cl. CPC A62D 3/38; B01D 46/0027; B01D 53/04; B01D 53/06; B01D 53/75; B01D 53/78; B01D 53/8625; A62D 2101/22; B01D 2253/102; B01D 2253/206; B01D 2257/70

(57) ABSTRACT

Processes and apparatuses converting poly- and perfluoroalkyl substances (PFAS). An oxidation reaction zone, preferably a thermal oxidizer, is utilized to oxidize the PFAS into anionic fluoride species. A treatment zone is utilized on at least a portion of the oxidation zone effluent before the oxidation zone effluent is vented or otherwise released to the atmosphere. The treatment zone may include a dry sorbent injection zone; a selective catalytic reduction zone, a wet scrubber zone; a carbon bed; an ion exchange zone; or any combination thereof.

### RELATED APPLICATIONS

This application claims priority to U.S. Provisional Patent Application Ser. No. 63/518,029 filed on Aug. 7, 2023, the entirety of which is incorporated herein by reference.

### FIELD OF THE INVENTION

This invention relates generally to processes and apparatuses for removing and converting poly- and perfluoroalkyl substances.

### BACKGROUND OF THE INVENTION

Poly- and perfluoroalkyl substances (“PFAS”) are “forever chemicals” that are very stable and persist in the environment. These forever chemicals are linked to harmful effects on the kidney, liver, blood, and immune system. Examples of such chemicals are surfactants in industrial and consumer products, such as firefighting foams, alkaline cleaners, paints, non-stick cookware, carpets, upholstery, shampoos, floor polishes, fume suppressants, semiconductors, photographic films, pesticide formulations, food packing, masking tape, and denture cleaners.

The EPA has a list of over 179 PFAS that are known or believed to be toxic and it is believed that this list will grow as there are more than 12,000 different PFAS. Currently, the EPA advises a maximum limit of <70 ppt of PFAS, however stricter EPA regulations and limits have been proposed.

Given the health risks associated with PFAS and their environmental impact, there is an ongoing need for processes and apparatuses which effectively and efficiently remove and convert PFAS.

### SUMMARY OF THE INVENTION

The present invention provides for the removal and conversion of PFAS. The PFAS may be oxidized in a thermal oxidizer and then the oxidation effluent is subjected to a treatment in a treatment zone. The treatment zone may include a dry sorbent injection zone, a wet scrubber zone, a carbon bed, a selective catalytic reaction zone, and/or an ion exchange zone.

The present processes may be utilized with liquid PFAS, allowing streams to be injected into a thermal oxidizer, without requiring separate vaporizing equipment. Further the direct injection reduces the residence time and minimizes the size of the apparatus needed.

Therefore, the present invention may be characterized, in at least one aspect, as providing a process for converting poly- and perfluoroalkyl substances (PFAS) by: oxidizing, in an oxidation zone, a feed stream comprising liquid PFAS to provide an oxidation effluent comprising a reduced amount of liquid PFAS compared to the feed stream; and, treating the oxidation effluent in a treatment zone to provide a treated effluent, wherein the treatment zone comprises: a dry sorbent injection zone; a selective catalytic reaction zone; a wet scrubber zone; a carbon bed; an ion exchange zone; or any combination thereof.

Between 90 to 99.9999% of the PFAS in the feed stream may be thermally oxidized in the thermal oxidation zone.

The oxidizing may be performed at a temperature between about 500° C. to about 2,300° C.

A residence time of the PFAS in the thermal oxidation zone may be between 0.1 to 30 seconds.

The process may further include cooling, in a thermal reduction zone, the oxidation effluent before the treating in the treatment zone.

The treatment zone may include the dry sorbent injection zone and the process may include: mixing a reactant with the oxidation effluent to provide the treated effluent, and wherein the reactant includes a salt with sodium, calcium, potassium, magnesium, aluminum, silicon or any combination thereof in a solution or mixture. The reactant may be a mixture of a fresh reactant and a recycled reactant. The process may include quenching the treated effluent from the treatment zone. The dry sorbent injection zone may include a filtration zone configured to separate the treated effluent and provide a residue stream and a vent gas stream. The process may include recycling the residue stream to the dry sorbent injection zone as at least a portion of the reactant. The treatment zone may include the selective catalytic reaction zone, and the selective catalytic reaction zone may receive the vent gas stream from the filtration zone.

The treatment zone may include the wet scrubber zone, and the process may also include mixing an aqueous caustic stream with the oxidation effluent to provide the treated effluent. The aqueous caustic stream may include sodium, calcium, potassium, magnesium, or any combination thereof. The process may include separating the treated effluent into a liquid stream and a vent gas stream. The liquid stream may be mixed with the feed stream before introducing the feed stream to the thermal oxidation zone, or wherein the liquid stream may be passed as a quench fluid into the thermal oxidation zone, or both. The treatment zone may include the carbon bed, the ion exchange zone, or both, and the process may also include passing the liquid stream to the carbon bed or the ion exchange zone before the liquid stream is mixed with the feed stream or is passed as the quench fluid.

The treatment zone may include the carbon bed, the ion exchange zone, or both, and also include a sensor configured to provide a measurement, and the carbon bed or the ion exchange zone may receive a liquid portion of the treated effluent. The process may include determining a fluorine concentration in the liquid portion of the treated effluent from the measurement. The process may further include monitoring the fluorine concentration in the liquid portion of the treated effluent. The process may include adjusting a process condition when the fluorine concentration is outside of a predetermined range.

The process may include thermally reducing a temperature of the oxidation zone effluent before the treating.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

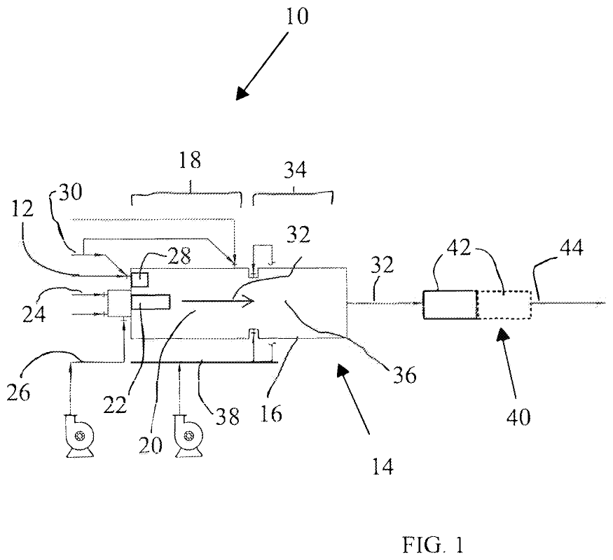

FIG. 1 shows a process flow diagram according to one or more aspects of the present invention;

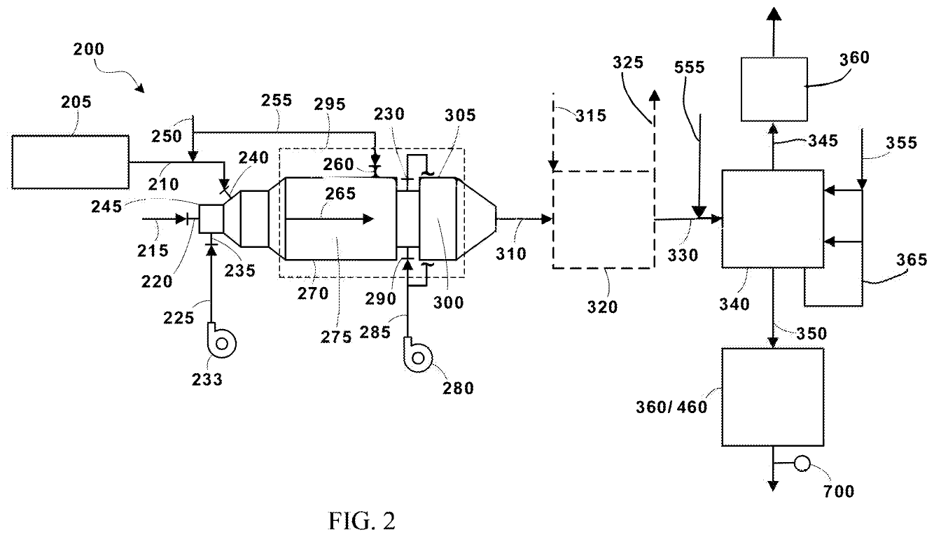

FIG. 2 shows a process flow diagram according to one or more aspects of the present invention;

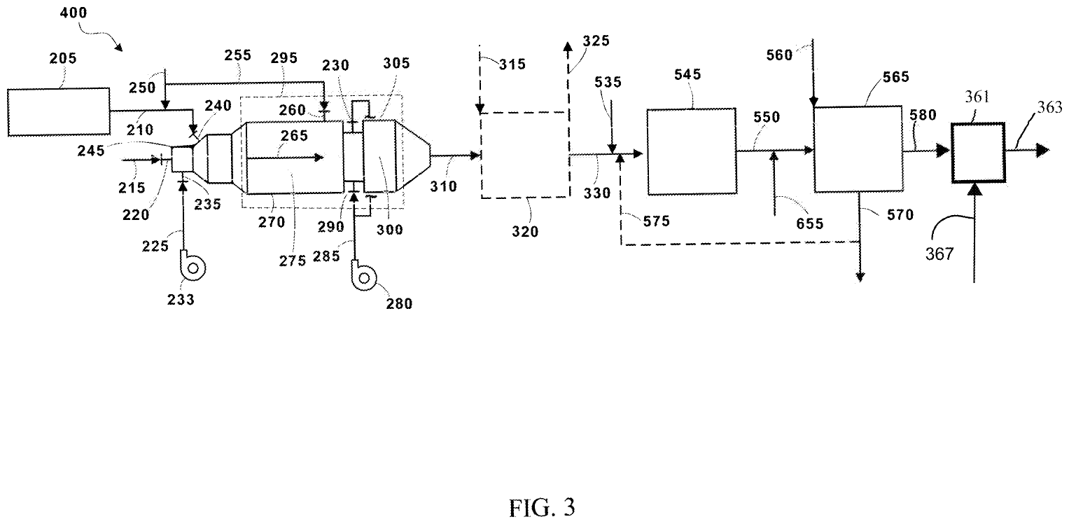

FIG. 3 shows a process flow diagram according to one or more aspects of the present invention; and,

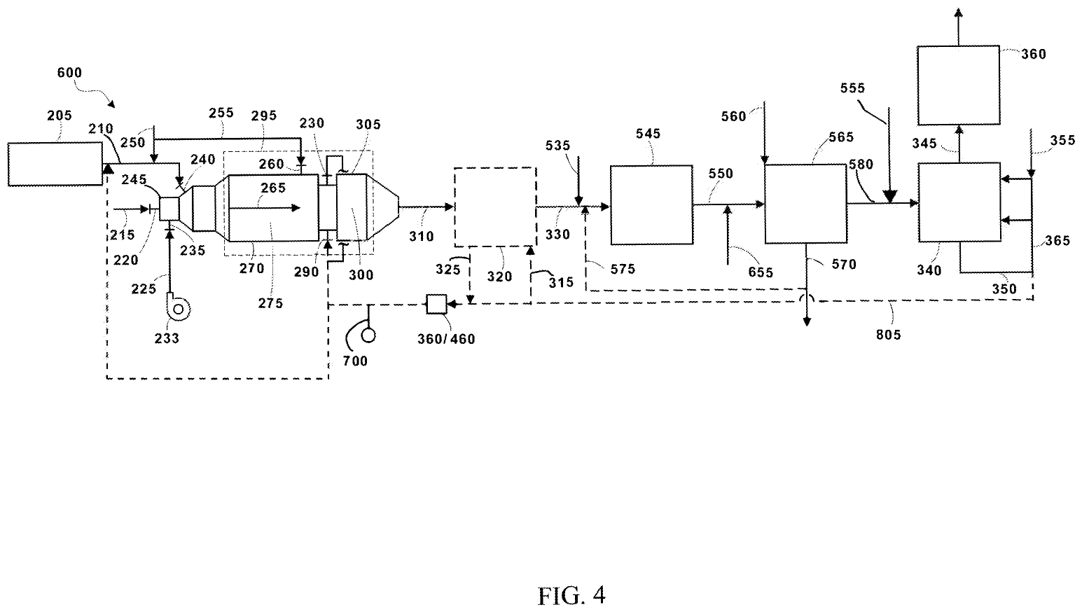

FIG. 4 shows a process flow diagram according to one or more aspects of the present invention.

### DETAILED DESCRIPTION OF THE INVENTION

As mentioned above, the present invention provides for the removal and conversion of PFAS. The PFAS may be oxidized in a thermal oxidizer and an oxidation zone effluent is passed to a treatment zone before a treated oxidation effluent is vented or otherwise released to the atmosphere/environment.

As used herein, “PFAS” means fluorine containing compounds, including, poly- and perflouroalky substances, that include at least one fully fluoridated methyl or methylene carbon atom. Commonly made, used and found compounds include perfluorooctanoic acid (PFOA), perfluorooctanesulfonic acid (PFOS), perfluorobutane sulfonic acid (PFBS), perfluoropentanesulfonic acid (PFPS), perfluorohexane sulfonic acid (PFHxS), perfluoroheptanesulfonic acid PFHpS), perfluorononanesulfonic acid (PFNS), or perfluorodecanesulfonic acid (PFDS), hexafluoropropylene oxide dimer acid (HFPO-DA). This list is not intended to be exhaustive, but merely exemplary. Additional PFAS compounds, can be found, for example in the definitions provided by the EPA. Additionally, it should be understood that “PFAS” also refers to the intermediate compounds produced during the conversion of an original PFAS compound.

As used herein, the term “substantially” can mean an amount generally of at least 90%, preferably 95%, and optimally 99%, by weight, of a compound or class of compounds in a stream.

As depicted, process flow lines in the figures can be referred to interchangeably as, e.g., lines, pipes, feeds, effluents, products, or streams.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

With these general principles in mind, one or more embodiments of the present invention will be described with the understanding that the following description is not intended to be limiting.

Turning to FIG. 1, in apparatus 10 for converting PFAS receives a feed stream 12 that contains liquid PFAS. In various embodiments, the feed stream 12 is a liquid feed stream that includes PFAS in liquid form, either in liquid phase or as dissolved solid phase PFAS. It is contemplated that the feed stream 12 comprises about 0.01 wt % PFAS, or comprises about 10 wt % PFAS. However, these amounts are merely exemplary and not intended to be limiting. Further, by “about” it is meant to include +/−10% of the stated amount.

The feed stream 12 is passed to an oxidation zone 14 containing at least one reactor vessel 16. In the oxidation zone 14, the PFAS will be oxidized into, among other components, anionic fluoride species. In a preferred embodiment, the oxidation zone 14 comprises a thermal oxidation zone 18 in which at least a portion of the reactor vessel 16 comprises a thermal oxidizer 20. Accordingly, an oxidation effluent may also comprise combustion products.

As is known, the thermal oxidizer 20 includes one or more burners 22 that receive a fuel gas stream 24 and a combustion air stream 26 which react in the thermal oxidation zone 18 to produce a flame. Contemplated temperatures for the thermal oxidation zone 18 are sufficient to oxidize the PFAS and may be between about 500° C. to about 2,300 C. Additionally, contemplated residence time may be between 0.1 to 30 seconds, such as between 0.5 to 15 seconds. Again, these are merely contemplated or exemplary values and are not intended to be limiting.

The feed stream 12 may be injected into the thermal oxidation zone 18. One or more injection nozzles 28 may be provided within the reactor vessel 16 to inject the feed stream 12 into the thermal oxidation zone 18. Prior to passing into the reactor vessel 16, the feed stream 12 may be atomized. For example, the feed stream 12 may be atomized with an atomization fluid 30, for example air, and then the atomization fluid and liquid PFAS (that is atomized) may be injected into the thermal oxidation zone 18. Alternatively, the feed stream 12 may be atomized with a mechanical atomizer, and thus, no separate atomization fluid 30 may be needed to atomize the feed stream 12.

According to the present processes at least 90 wt %, or between 90 to 99.999 wt %, or between 90 to 99.9999 wt % of the PFAS from the feed stream 12 is converted to the anionic fluoride species in the oxidation zone 14. In some embodiments, 100 wt % of the PFAS is converted to the anionic fluoride species in the oxidation zone 14.

In order to remove any unwanted or harmful components of the oxidation zone effluent 32, a treatment zone 40 is utilized. However, prior to the treatment zone 40, the oxidation zone effluent 32 may be cooled in a thermal reduction zone 34, or cooling zone, so that a temperature of the oxidation zone effluent 32 is reduced, preferably by at least 5%.

The thermal reduction zone 34 may include a heat exchange zone with a heat exchanger configured to transfer heat from the oxidation zone effluent 32 to a heat exchange fluid. The heat exchanger could be located within the reactor 16 or it could be located externally.

Additionally, or alternatively, the thermal reduction zone 34 may include a quench zone 36 that may be a portion of the reactor vessel 16 in the oxidation zone 14. The quench zone 36 receives a quench fluid 38 may be injected into the quench zone. The quench fluid 38 may be water, air, or a combination thereof.

In some embodiments, a sensor (not shown) or other monitoring device may be utilized to measure a temperature of the oxidation zone effluent 32 at various points (i.e., upstream of the thermal reduction zone 34 and/or downstream of the thermal reduction zone 34). The obtained or measured temperature may be compared to a predetermined temperature or other set point a flow of a cooling fluid (i.e., a heat exchange fluid and/or quench fluid 38) may be adjusted in response to the comparison to raise or lower the temperature of the oxidation zone effluent 32.

With or without thermal reduction, the oxidation zone effluent 32 is passed to the treatment zone 40 to reduce and/or remove any unwanted or harmful compounds. The treatment zone 40 may contain one or more treaters 42. As will be described in more detail below, the treaters 42 may have a dry sorbent injection zone, a wet scrubber zone, a carbon bed, a selective catalytic reduction zone, and/or an ion exchange zone. After passing through the one or more treaters 42 of the treatment zone 40, a treated oxidation zone effluent 44 may be released to the atmosphere. Specific embodiments will be described with the understanding that the specific treaters 42 included in the treatment zone, as well as the order of same, is merely exemplary and one of ordinary skill in the art will appreciate that the treaters 42 may be combined in any number and any order.

Turning to FIG. 2, an apparatus 200 for converting PFAS according to the present invention may include a thermal oxidation zone, or section, 295, a heat exchanger 320, and a treatment zone which includes a wet scrubber zone 340 for removing an anionic fluoride species contaminant from the oxidation effluent. The wet scrubber zone 340 will reduce the chances of release of light fluorinated carbon and hydrofluorocarbons or other components from the oxidation of the PFAS. Additionally, the wet scrubber zone 340 will neutralize hydrogen fluoride that is produced in the oxidation.

The apparatus 200 receives a feed stream 210 which may be from a PFAS concentration tank 205, although this may not be needed. In various embodiments, the feed stream 210 is a feed stream that includes PFAS in liquid form, either in liquid phase or as dissolved solid phase PFAS. It is contemplated that the feed stream 210 comprises around 0.01 wt % PFAS or around 10 wt % PFAS. However, these amounts are merely exemplary and not intended to be limiting. Further, by “around” it is meant to include +/−10% of the stated amounts.

The thermal oxidation zone 295 contains one or more injection nozzles such as a combustion air injection nozzle 235, fuel gas injection nozzle 220, PFAS waste stream injection nozzle 240, atomization fluid injection nozzle, heat exchange fluid and/or quench fluid injection nozzles 230, 260 and 290.

The feed stream 210 is passed through the PFAS waste stream injection nozzle 240 to the thermal oxidation zone 295 containing at least one reactor vessel 270. In the thermal oxidation zone 295, the PFAS will be oxidized into, among other components, anionic fluoride species. In a preferred embodiment, the thermal oxidation zone 295 comprises a thermal oxidizer 275. Accordingly, the oxidation zone effluent 310 may also comprise combustion products.

The feed stream 210 may be injected into the thermal oxidizer 275. Prior to passing into the thermal oxidizer 275, the feed stream 210 may be atomized. For example, the feed stream 210 may be atomized with an atomization fluid 250, for example air, and then the atomization fluid and liquid PFAS (that is atomized) may be injected into the thermal oxidizer 275. Alternatively, the feed stream 210 may be atomized with a mechanical atomizer, and thus, no separate atomization fluid 250 may be needed to atomize the feed stream 210.

As is known, the thermal oxidizer 275 includes one or more burners 245 that receive a fuel gas stream 215 through the fuel gas injection nozzle 220 and a combustion air stream 225 through the combustion air injection nozzle 235 (from the combustion air blower 233) which will react in the thermal oxidation burners to produce a flame. Contemplated temperatures for the thermal oxidizer 275 are sufficient in oxidizing the PFAS and may be between 500° C. to around 2,300° C. Additionally, contemplated residence time may be between 0.1 to 30 seconds, for example between 0.5 to 15 seconds. Again, these are merely contemplated or exemplary values and are not intended to be limiting.

According to the present processes, at least 90 wt %, or between 90 to 99.999 wt %, or between 90 to 99.9999 wt % of the PFAS from the feed stream 210 is converted to the fluoride species in the thermal oxidation zone 295. In order to reduce the concentration of the fluoride species, the oxidation zone effluent 310 is passed through the wet scrubber zone 340, the oxidation zone effluent 310 may be cooled in a thermal reduction zone 305, or cooling zone, so that the temperature of the oxidation zone effluent 310 is reduced.

Additionally, or alternatively, the thermal reduction zone 305 may include a quench zone 300 that may be a portion of the thermal oxidizer 275 in the thermal oxidation zone 295. The quench zone 300 receives a quench fluid 285 from a quench fluid blower 280 (which may be a pump if the quench fluid 285 is a liquid). The quench fluid 285 may be water, air, or a combination thereof.

Additionally, or alternatively, a heat exchange zone with a heat exchanger 320 may be provided to a transfer heat from the oxidation zone effluent 310 with a heat exchange fluid. The heat exchanger 320 could be located within the thermal oxidation zone 295, or it could be located externally.

The oxidation zone effluent 310 may enter the heat exchanger 320 where the oxidation zone effluent 310 is cooled with a heat exchange fluid 315 which can be boiler feed water, or combustion air, or oil feedstock, to form a heated stream 325. If the heated stream 325 is boiler feed water, it can be sent to a Heat Recovery Steam Generator (HRSG) saturated stream unit. If the heated stream 325 is oil feed stock, it can be sent to the hot oil system of a main process unit. Alternately, or additionally, all or a portion the heated stream 325 can be sent to other areas of the plant as needed.

In some embodiments, a sensor (not shown) or other monitoring device may be utilized to measure a temperature in the oxidation zone effluent 310 and/or the cooled oxidation zone effluent 330 at various points (i.e., upstream of the thermal reduction zone 305 and/or downstream of the thermal reduction zone 305 and/or downstream of the heat exchanger 320). The obtained or measured temperature may be compared to a predetermined temperature or setpoint a flow of cooling fluid (i.e., a heat exchange fluid 315 and/or quench fluid 285) may be adjusted in response to the comparison to raise or lower the temperature of the oxidation zone effluent 310 or the cooled oxidation zone effluent 330.

The cooled oxidation zone effluent 330 is passed to the wet scrubber zone 340 to minimize emission of light fluorinated hydrocarbons. The temperature of the oxidation zone effluent 330 is reduced to the saturation temperature using an aqueous stream 555. An aqueous caustic stream 355 may be introduced to the wet scrubbing zone 340 near a top of a column, so that the caustic stream flows downwards and contacts the cooled oxidation zone effluent 330 which flows upward.

The inlet temperature for the wet scrubber zone 340 is typically in the range of 45° C.-150° C. with a pressure of −12 kPa (g) to 50 kPa (g). The outlet temperature for the wet scrubber zone 340 is typically in the range of 45° C.-75° C. with a pressure of −15 kPa (g) to 50 kPa (g). The operating parameters of the wet scrubber zone 340 are merely contemplated or exemplary values and are not intended to be limiting.

The aqueous caustic stream 355 may include compounds having sodium, calcium, potassium, magnesium, or any combination thereof such as NaHCO₃, NaOH, KOH, K₂CO₃, CaOH, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaSO₄·2(H₂O), CaO, CaCO₃·MgCO₃. Reactions that take place in the wet scrubber zone 340 may lead to the formation and/or conversion of fluoride components including, but not limited to, H₂O, CaCl₂), CaF, CaF₂, CaCO₃, Na₂CO₃, NaCl, CO₂, Na₂NO₃, NaCl, NaF, K₂CO₃, KNO₃, KCl, KF, MgCl₂, MgCO₃, Mg(NO₃)₂, to name a few.

An effluent of the wet scrubber zone 340 may be separated into various streams. For example, a vent gas 345 from the wet scrubber zone 340 has a reduced level of anionic fluoride species compared to the cooled oxidation zone effluent 330. The vent gas 345 can be vented from a stack in the wet scrubber zone 340 to the atmosphere. One or more liquid streams 350, 365 can be generated which can be an aqueous stream 350 released to the environment or a recycle stream 365 which can be passed back into the wet scrubber zone 340.

It is contemplated that a carbon bed 360 and/or an ion exchange zone 460 are provided before the aqueous stream 350 or vent gas stream 345 is released. As is known, a carbon bed 360 includes material such as activated carbon, reticulated vitreous carbon foam, carbon aerogel, sheets of carbon paper, carbon fiber or carbon fiber containing composites, carbon fiber aerogel, graphene, graphene aerogel, graphene oxide media, additive printed carbon, additive printed graphene, graphitized media, ionized carbon/noncarbon and magnetized carbon/non-carbon media, and electrically charged carbon media. The material adsorbs various compounds like furans and dioxins.

Similarly, the ion exchange zone 460 contains a medium, typically a resin, that selectively removes ions from the stream. The material in the ion exchange zone 460 may be selected for PFAS and other fluorinated species. The material should be tolerant to NaCl and NaOH, as well as dissolved gases.

Additionally, a sensor 700 may be utilized to obtain a measurement that can be utilized to determine a fluorine concentration. For example, the sensor 700 could directly measure the fluorine concentration in the respective stream or vessel. Alternatively, the sensor 700 may measure some other attribute, condition, or parameter of the stream which could be utilized to determine a fluorine concentration, for example with a look-up table. The determined fluorine concentration may be monitored and utilized to ensure that the fluorine level is suitable for release of the respective stream(s). Thus, it should be appreciated, that the depicted location of the sensor 700 is merely exemplary and not limiting. Additionally, based on the fluorine concentration, a controller (not shown) may send signals to other equipment to adjust various processing conditions, like flow rate, temperature, etc., so as to impart a change in the process in an attempt to adjust the fluorine level of the respective stream.

Turning to FIG. 3, an apparatus 400 includes a treatment zone that includes a dry sorbent injection zone 545 and a selective catalytic reduction zone 361. Portions of the apparatus 400 that are the same or similar as apparatus 200 shown in FIG. 2, have the same reference numbers and the description of same is hereby incorporated by reference.

In the apparatus of FIG. 3, the cooled oxidation effluent 330 is mixed with a reactant that may include a fresh reactant 535 and a recycled reactant 575. Within the dry sorbent injection zone 545, the reactant reacts with various fluoride species, dioxins, and furans in the cooled oxidation effluent 330.

The reactant includes a salt with sodium, calcium, potassium, magnesium, aluminum, silicon or any combination thereof in a solution or mixture. For example, the reactant may include one or more of H₂O, CaCl₂, CaF, CaF₂, CaCO₃, Na₂CO₃, NaCl, CO₂, Na₂NO₃, NaCl, NaF, K₂CO₃, KNO₃, KCl, KF, MgCl₂, MgCO₃, Mg(NO₃)₂, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃: MgCO₃, (Ca(OH)₂·(Mg(OH)₂).

An inlet temperature for the dry sorbent injection zone 545 is typically in a range of 200° C.-600° C. with a pressure of −3 kPa (g) to 50 kPa (g). An outlet temperature for the dry sorbent injection zone 545 is typically in the range of 150° C.-600° C. with a pressure of −5 kPa (g) to 50 kPa (g). The operating parameters of the dry sorbent injection zone 545 are merely contemplated or exemplary values and are not intended to be limiting.

A treated effluent 550 has a reduced level of fluoride species compared to the cooled oxidation effluent 330. The treated effluent 550 may be combined with a quench stream 655 including air, and/or water, and/or quenched flue gas and/or inert gas or any mixture thereof.

The treated effluent 550 may be passed to a filtration zone 565 for the removal of at least one of H₂O, CaCl₂), CaF, CaF₂, CaCO₃, Na₂CO₃, NaCl, CO₂, NazNO₃, NaCl, NaF, K₂CO₃, KNO₃, KCl, KF, MgCl₂, MgCO₃, Mg(NO₃)₂, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃: MgCO₃, (Ca(OH)₂·(Mg(OH)₂), organic acids and fine particulate matter. An inlet temperature for the filtration zone 565 is typically in a range of 150° C.-600° C. with a pressure of −5 kPa (g) to 50 kPa (g). An outlet temperature for the filtration zone 565 is typically in a range of 150° C.-600° C. with a pressure of −7 kPa (g) to 50 kPa (g). The operating parameters of the filtration zone 565 are merely contemplated or exemplary values and are not intended to be limiting.

The filtration zone 565 may include a bag filter, and/or ceramic filter, and/or an electrostatic precipitator (ESP) for separation of solid particles from a gaseous portion. An instrument air purge or high voltage DC 560 is introduced into the filtration zone 565. In the case of the instrument air purge, it purges the retained material from the filter. In the case of the high voltage stream, it charges the cathodes of the ESP. The particulate may be removed from the ESP by vibration. A residue stream 570 comprising of at least one H₂O, CaCl₂), CaF, CaF₂, CaCO₃, Na₂CO₃, NaCl, CO₂, NazNO₃, NaCl, NaF, K₂CO₃, KNO₃, KCl, KF, MgCl₂, MgCO₃, Mg(NO₃)₂, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃: MgCO₃, (Ca(OH)₂·(Mg(OH)₂), organic acids and fine particulate matter depending exits the filtration zone 565. All or a portion of the residue stream 570 may be utilized for the recycled reactant 575 to increase the conversion yield of the reactant (i.e. from 85 wt % to 98 wt %). A vent gas stream 580 may be vented from a stack in the filtration zone 565 to the atmosphere.

However, it is also contemplated that a selective catalytic reaction zone 361 be provided to reduce or remove nitrogen oxides in the vent gas stream 580. More specifically, it is known that some PFAS includes a nitrogen component or PFAS containing feed may include a co-contaminant, such as amines, ammonia or nitrogen oxides. Example quaternary ammoniums include fluorinated amine oxide surfactants, PFOAAmS, PFOSAmS, PFOAB, PFOSB, and PFOSAm.

The vent gas stream 580 may be passed to a reactor in the selective catalytic reaction zone 361 where nitrogen oxides (NOX) exiting the filtration zone 565 is reacted. The selective catalytic reaction zone 361 provides a SCR reactor effluent stream 363 with a reduced level of nitrogen oxides compared to the vent gas stream 580 stream.

The reactor in the selective catalytic reaction zone 361 may include any suitable SCR catalyst, including but not limited to, ceramic carrier materials such as titanium oxide with active catalytic components such as oxides of base metals including TiO₂, WO₃ and V₂O₅, or an activated carbon-based catalyst. An ammonia and/or urea stream 367 may be introduced into the reactor of the selective catalytic reaction zone 361 where it reacts with the NOX present in the vent gas stream 580. An inlet temperature for the reactor in the selective catalytic reaction zone 361 is typically in a range of 150° C. to 300° C. with a pressure of −8 kPa (g) to 50 kPa (g). An outlet temperature for the reactor in the selective catalytic reaction zone 361 is typically in the range of 150° C.-350° C. with a pressure of −9 kPa (g) to 50 kPa (g).

Turning to FIG. 4, an apparatus 600 is shown in which the treatment zone includes both the dry sorbent injection zone 545, the filtration zone 565, and the wet scrubber zone 340. Although not depicted as such, it is contemplated that the apparatus 600 also includes the selective catalyst reaction zone 361 (see FIG. 3), preferably between the filtration zone 565 and the wet scrubber zone 340. Thus, portions of the apparatus 600 that are the same or similar as apparatus 200 shown in FIG. 2 and the apparatus 400 shown in FIG. 3 have the same reference numbers and the description of same is hereby incorporated by reference.

In FIG. 4, the vent gas stream 580 is passed to the wet scrubber zone 340 and is processed as discussed above. The aqueous recycle stream 350, 805 may be passed back to the wet scrubber zone 340. Additionally, it may be recycled to the thermal oxidation zone 295 for example is mixed with feed stream 210 or utilized as a quench fluid in the quench zone 300 of the thermal oxidation zone 295. Further, it is contemplated that the aqueous recycle stream 350, 805 is utilized as the heat exchange fluid 315 for the heat exchanger 320 before being utilized as quench fluid.

Additionally, FIG. 4 shows a carbon bed 360 which may be utilized to remove dioxins and/or furans from the vent gas stream 345 from the wet scrubber zone 340. Finally, the aqueous recycled stream 350 may be passed to a carbon bed 360 and/or ion exchange zone 460 before being passed to the thermal oxidation zone 295. Again, a sensor 700 may be utilized to obtain a measurement that may be utilized to obtain a fluorine level in the aqueous recycled stream 805.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be utilized to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps.

For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

### Specific Embodiments

While the following is described in conjunction with specific embodiments, it will be understood that this description is intended to illustrate and not limit the scope of the preceding description and the appended claims.

A first embodiment of the invention is a process for converting poly- and perfluoroalkyl substances (PFAS), the process comprising oxidizing, in an oxidation zone, a feed stream comprising liquid PFAS to provide an oxidation effluent comprising a reduced amount of liquid PFAS compared to the feed stream; and, treating the oxidation effluent in a treatment zone to provide a treated effluent, wherein the treatment zone comprises a dry sorbent injection zone; a selective catalytic reaction zone; a wet scrubber zone; a carbon bed; an ion exchange zone; or any combination thereof. An embodiment of the invention is one, any or all of prior embodiments in this paragraph up through the first embodiment in this paragraph, wherein between 90 to 99.9999% of the PFAS in the feed stream is thermally oxidized in the thermal oxidation zone. An embodiment of the invention is one, any or all of prior embodiments in this paragraph up through the first embodiment in this paragraph, wherein the oxidizing is performed at a temperature between about 500° C. to about 2,300° C. An embodiment of the invention is one, any or all of prior embodiments in this paragraph up through the first embodiment in this paragraph, wherein a residence time of the PFAS in the thermal oxidation zone is between 0.1 to 30 seconds. An embodiment of the invention is one, any or all of prior embodiments in this paragraph up through the first embodiment in this paragraph further comprising cooling, in a thermal reduction zone, the oxidation effluent before the treating in the treatment zone. An embodiment of the invention is one, any or all of prior embodiments in this paragraph up through the first embodiment in this paragraph, wherein the treatment zone comprises the dry sorbent injection zone and wherein the process further comprises mixing a reactant with the oxidation effluent to provide the treated effluent, and wherein the reactant includes a salt with sodium, calcium, potassium, magnesium, aluminum, silicon or any combination thereof in a solution or mixture. An embodiment of the invention is one, any or all of prior embodiments in this paragraph up through the first embodiment in this paragraph, wherein the dry sorbent injection zone the reactant comprises a mixture of a fresh reactant and a recycled reactant. An embodiment of the invention is one, any or all of prior embodiments in this paragraph up through the first embodiment in this paragraph, wherein the process further comprises quenching the treated effluent from the treatment zone. An embodiment of the invention is one, any or all of prior embodiments in this paragraph up through the first embodiment in this paragraph, wherein the dry sorbent injection zone comprises a filtration zone configured to separate the treated effluent and provide a residue stream and a vent gas stream. An embodiment of the invention is one, any or all of prior embodiments in this paragraph up through the first embodiment in this paragraph, further comprising recycling the residue stream to the dry sorbent injection zone as at least a portion of the reactant. An embodiment of the invention is one, any or all of prior embodiments in this paragraph up through the first embodiment in this paragraph, wherein the treatment zone comprises the selective catalytic reaction zone, and wherein the selective catalytic reaction zone receives the vent gas stream from the filtration zone. An embodiment of the invention is one, any or all of prior embodiments in this paragraph up through the first embodiment in this paragraph, wherein the treatment zone comprises the wet scrubber zone, and wherein the process further comprises mixing an aqueous caustic stream with the oxidation effluent to provide the treated effluent. An embodiment of the invention is one, any or all of prior embodiments in this paragraph up through the first embodiment in this paragraph, wherein the aqueous caustic stream comprises sodium, calcium, potassium, magnesium, or any combination thereof. An embodiment of the invention is one, any or all of prior embodiments in this paragraph up through the first embodiment in this paragraph, further comprising separating the treated effluent into a liquid stream and a vent gas stream. An embodiment of the invention is one, any or all of prior embodiments in this paragraph up through the first embodiment in this paragraph, wherein the liquid stream is mixed with the feed stream before introducing the feed stream to the thermal oxidation zone, or wherein the liquid stream is passed as a quench fluid into the thermal oxidation zone, or both. An embodiment of the invention is one, any or all of prior embodiments in this paragraph up through the first embodiment in this paragraph, wherein the treatment zone comprises the carbon bed, the ion exchange zone, or both, and wherein the process further comprises passing the liquid stream to the carbon bed or the ion exchange zone before the liquid stream is mixed with the feed stream or is passed as the quench fluid. An embodiment of the invention is one, any or all of prior embodiments in this paragraph up through the first embodiment in this paragraph, wherein the treatment zone comprises the carbon bed, the ion exchange zone, or both, and further comprises a sensor configured to provide a measurement, and wherein the carbon bed or the ion exchange zone receive a liquid portion of the treated effluent, and the process further comprising determining a fluorine concentration in the liquid portion of the treated effluent from the measurement. An embodiment of the invention is one, any or all of prior embodiments in this paragraph up through the first embodiment in this paragraph further comprising monitoring the fluorine concentration in the liquid portion of the treated effluent. An embodiment of the invention is one, any or all of prior embodiments in this paragraph up through the first embodiment in this paragraph further comprising adjusting a process condition when the fluorine concentration is outside of a predetermined range.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for converting poly- and perfluoroalkyl substances (PFAS), the process comprising:
oxidizing, in an oxidation zone, a feed stream comprising liquid PFAS to provide an oxidation effluent comprising a reduced amount of liquid PFAS compared to the feed stream; and,
treating the oxidation effluent in a treatment zone to provide a treated effluent, wherein the treatment zone comprises:
a dry sorbent injection zone;
a selective catalytic reaction zone;
a wet scrubber zone;
a carbon bed;
an ion exchange zone;
or any combination thereof.

2. The process of claim 1, wherein between 90 to 99.9999% of the PFAS in the feed stream is thermally oxidized in the thermal oxidation zone.

3. The process of claim 1, wherein the oxidizing is performed at a temperature between about 500° C. to about 2,300° C.

4. The process of claim 1, wherein a residence time of the PFAS in the thermal oxidation zone is between 0.1 to 30 seconds.

5. The process of claim 1 further comprising:
cooling, in a thermal reduction zone, the oxidation effluent before the treating in the treatment zone.

6. The process of claim 1, wherein the treatment zone comprises the dry sorbent injection zone and wherein the process further comprises:
mixing a reactant with the oxidation effluent to provide the treated effluent, and wherein the reactant includes a salt with sodium, calcium, potassium, magnesium, aluminum, silicon or any combination thereof in a solution or mixture.

7. The process of claim 6, wherein the dry sorbent injection zone the reactant comprises a mixture of a fresh reactant and a recycled reactant.

8. The process of claim 6, wherein the process further comprises:
quenching the treated effluent from the treatment zone.

9. The process of claim 6, wherein the dry sorbent injection zone comprises a filtration zone configured to separate the treated effluent and provide a residue stream and a vent gas stream.

10. The process of claim 9, further comprising:
recycling the residue stream to the dry sorbent injection zone as at least a portion of the reactant.

11. The process of claim 9, wherein the treatment zone comprises the selective catalytic reaction zone, and wherein the selective catalytic reaction zone receives the vent gas stream from the filtration zone.

12. The process of claim 1, wherein the treatment zone comprises the wet scrubber zone, and wherein the process further comprises:
mixing an aqueous caustic stream with the oxidation effluent to provide the treated effluent.

13. The process of claim 12, wherein the aqueous caustic stream comprises sodium, calcium, potassium, magnesium, or any combination thereof.

14. The process of claim 12, further comprising:
separating the treated effluent into a liquid stream and a vent gas stream.

15. The process of claim 14, wherein the liquid stream is mixed with the feed stream before introducing the feed stream to the thermal oxidation zone, or wherein the liquid stream is passed as a quench fluid into the thermal oxidation zone, or both.

16. The process of claim 15, wherein the treatment zone comprises the carbon bed, the ion exchange zone, or both, and wherein the process further comprises passing the liquid stream to the carbon bed or the ion exchange zone before the liquid stream is mixed with the feed stream or is passed as the quench fluid.

17. The process of claim 1, wherein the treatment zone comprises the carbon bed, the ion exchange zone, or both, and further comprises a sensor configured to provide a measurement, and wherein the carbon bed or the ion exchange zone receive a liquid portion of the treated effluent, and the process further comprising:
determining a fluorine concentration in the liquid portion of the treated effluent from the measurement.

18. The process of claim 17 further comprising:
monitoring the fluorine concentration in the liquid portion of the treated effluent.

19. The process of claim 18 further comprising:
adjusting a process condition when the fluorine concentration is outside of a predetermined range.

20. The process of claim 1 further comprising:
thermally reducing a temperature of the oxidation zone effluent before the treating.
